(19) United States
(12) Patent Application Publication
(10) Pub. No.: US 2007/0109410 A1
(43) Pub. Date: May 17, 2007

(54) Apparatus for audio reproduction and image capturing

(75) Inventor: Mun Hin Siew, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/280,595

(22) Filed: Nov. 15, 2005

(51) Int. Cl. H04N 5/225

(52) U.S. Cl. 348/207.1

(57) ABSTRACT

Apparatus for audio reproduction and image capture having a housing with a first portion and a second portion. The first portion is moveable relative to the second portion between a first position and a second position. There is at least one loudspeaker driver mounted in the second portion for audio reproduction, and a web camera mounted to the first portion moveable at least laterally relative to the first portion. The first portion is adjustable when in the second position for aiming of the web camera.

### FIELD OF THE INVENTION

This invention relates to an apparatus for audio reproduction and image capturing and refers particularly, though not exclusively, to a loud speaker apparatus which includes a web camera.

### BACKGROUND OF THE INVENTION

A web camera (“webcam”) is a peripheral device for use with computers to enable images to the captured by the computer and, if required, for those images to be transmitted over the Internet, saved on the computer, or otherwise used, sent or printed. Computer includes, but is not limited to, personal computers, desktop computers, laptop computers, notebook computers, tablet computers, and personal digital assistants.

In many cases the computer will also require speakers to be able to reproduce audio. This therefore requires two peripheral devices, with two connections. If a microphone is required for Internet telephony, for example, a third peripheral and third connection is required. While there are hubs that allow the connection of numerous add-on peripherals to a computer, the mass of wires that is a direct consequence of adding on too many peripherals becomes a bother. It becomes particularly bothersome and inconvenient especially when traveling. Having to carry several peripheral components during travel may be cumbersome and the peripheral components will also be prone to damage during travel.

### SUMMARY OF THE INVENTION

In accordance with a first preferred aspect there is provided apparatus for audio reproduction and image capture, the apparatus comprising a housing comprising a first portion and a second portion, the first portion being moveable relative to the second portion between a first position and a second position; at least one loudspeaker driver mounted in the second portion for audio reproduction; a web camera mounted to the first portion and being moveable at least laterally relative to the first portion; the first portion being adjustable when in the second position for aiming of the web camera.

The first portion may be pivotally attached to the second portion, and may have an outer surface and a front surface for enclosing the outer surface, the web camera being mounted to the front surface.

Alternatively, the first portion may have an arm pivotally attached to the second portion at an inner end of the arm a body at an outer end of the arm, the web camera being mounted to the body. The arm may be telescopic.

The second portion may have a shaped recess in which the first portion is releasably received when the first portion is in the first position. Alternatively, when the first portion is in the first position the first portion may be a cover for the second portion.

The second portion may have a base, a peripheral side wall, and a top surface; the base, peripheral side wall and top surface forming a hollow interior. The at least one loudspeaker driver may be mounted to the top surface. The shaped recess may be formed in the top surface.

The apparatus may further comprise at least one of: a built-in microphone, a line-out socket, a line-in socket, a mute button for the built-in microphone, a connector to digital devices and a switch for switching off the apparatus when the first portion is moved to the first position.

The hollow interior may be acoustically matched to the at least one loudspeaker driver.

When the first portion is in the first position, there may be a small gap between the front surface and the top surface; the first portion protecting the at least one loudspeaker driver and the second portion protecting the web camera.

There may be two spaced-apart loudspeaker drivers.

The apparatus may preferably be able to super-impose captured audio and images onto existing media content such as, for example, movies, music videos and filmlets. The captured audio and images may either be presented in a sub-window of a main display of the existing media content or on a main display with existing media content being presented in a sub-window.

### BRIEF DESCRIPTION OF THE DRAWINGS

In order that the present invention may be fully understood and readily put into practical effect, there shall now be described by way of non-limitative example only preferred embodiments of the present invention, the description being with reference to the accompanying illustrative drawings.

In the drawings:

FIG. 1 is a perspective view of a computer installation utilizing a first embodiment;

FIG. 2 is a view of first embodiment in a first configuration;

FIG. 3 is a view of the first embodiment in a second configuration;

FIG. 4 is a vertical cross-sectional view along the lines and in the direction of arrows 4-4 on FIG. 2;

FIG. 5 is a vertical cross-sectional view along the lines and in the direction of arrows 5-5 on FIG. 3;

FIG. 6 is a view corresponding to FIG. 2 of a second embodiment;

FIG. 7 is a view corresponding to FIG. 3 of the second embodiment; and

FIG. 8 is a view corresponding to FIG. 3 of the a third embodiment;

### DETAILED DESCRIPTION OF THE PREFERRED EMBODIMENTS

The following discussion is intended to provide a brief, general description of a suitable computing environment in which the present invention may be implemented. As those skilled in the art will appreciate, the invention may be practiced with other computer system configurations, including hand-held devices, multiprocessor systems, microprocessor-based or programmable consumer electronics, minicomputers, and the like.

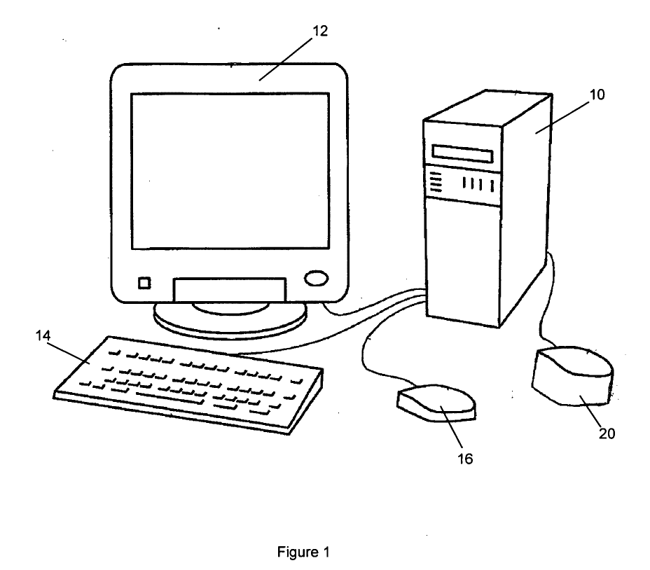

To refer to FIG. 1 there is shown a typical personal computer system comprising a central processor unit (“CPU”) 10, monitor 12, keyboard 14, mouse 16, and a web camera (“webcam”) speaker 20. Although shown connected to a personal computer system, the webcam speaker 20 may be used with any computer.

Computer includes, but is not limited to, personal computers, desktop computers, laptop computers, notebook computers, tablet computers, and personal digital assistants.

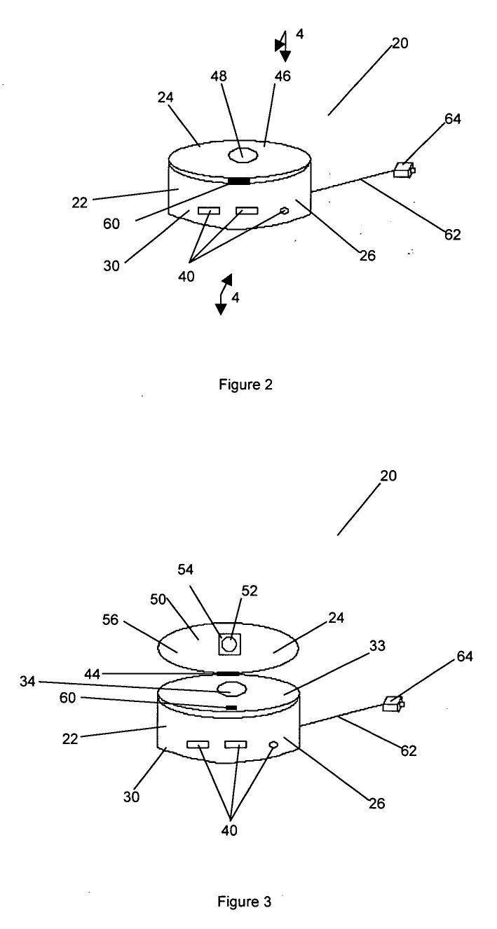

A first embodiment of the webcam speaker 20 is shown in more detail in FIGS. 2 to 5. The webcam speaker 20 has a housing 22 that has a first portion 24 and a second portion 26. The first portion 24 is shown as being pivotally connected to the second portion 26 by a hinge 44. However, any form of connection that allows the first portion 24 to move relative to the second portion 26 from a first position (FIG. 2) to a second position (FIG. 3) is satisfactory.

The second portion 26 has a hollow interior 27 defined by a base 28, peripheral wall or walls 30 and top 33. Base 28 may rest on feet 32.

Mounted in top 33 is at least one loudspeaker driver 34 for audio reproduction. The driver. 33 is operatively connected to electronic circuits 38 that provide the analog input to driver 33. Circuits 38 may be operatively connected to a power source 36 such as, for example, a battery, batteries, a battery pack or an external power source. Operatively connected to circuits 38 are functional controls 40 located in peripheral wall 30 and/or top 33. The controls 40 may be mounted on or connected to a printed circuit board 42.

A cable 62 is also operatively connected to the circuits 38 for operative connection to CPU 10. It is preferable that the cable 62 has at its end a connector 64 such as, for example, a USB or IEEE 1394 connector so that power can be supplied to the circuits 38 over cable 62 and thus power source 36 may not be required. Alternatively, the supplied power can also be used to recharge the power source 36.

Further alternatively a wireless connection may be used in place of cable 62. The wireless connection may be enabled by a wireless protocol such as, for example, Bluetooth, UWB, RF or IR. In this alternative embodiment, the power source 36 is mandatory to enable the webcam speaker 20 to function normally.

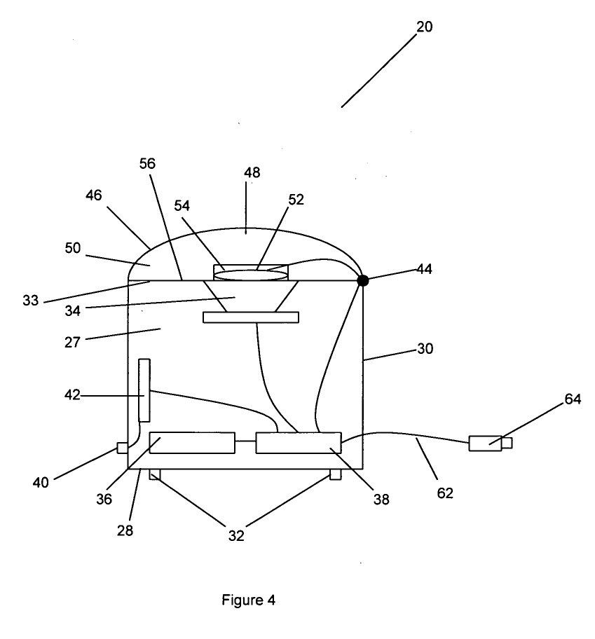

A catch 60 of a suitable construction and operation is also provided to releasably retain the first portion 24 in the first position as shown in FIGS. 2 and 4.

The first portion 24 may have a somewhat domed shaped formed by an outer surface 46. Preferably, the outer surface 46 has a central portion 48. A front surface 56 encloses the outer surface 46 to form a hollow interior 50. The front surface 56 is spaced from the central portion 48 by a distance sufficient to accommodate a lens 52 of a webcam mounted in a mounting 54 for at least lateral (side-to-side) movement relative to front surface 56. However, the mounting may be a ball joint to enable lateral and vertical adjustment of the lens 52 relative to mounting 54.

When the first portion 24 is in the first position as shown in FIGS. 2 and 4, the front surface 56 is spaced from the top surface 33 by a small gap 58. In his way the first portion 24 acts a cover for the second portion 26 and the lens 52 and driver 34 are protected—the first portion 24 providing protection for driver 34 from external damage, the second portion 26 providing protection for lens 52 from external damage, and the gap 58 providing protection for both driver 34 and lens 52 from damage due to components of the webcam speaker 20.

The second portion 26 is preferably acoustically matched to driver 34 for optimal acoustic performance.

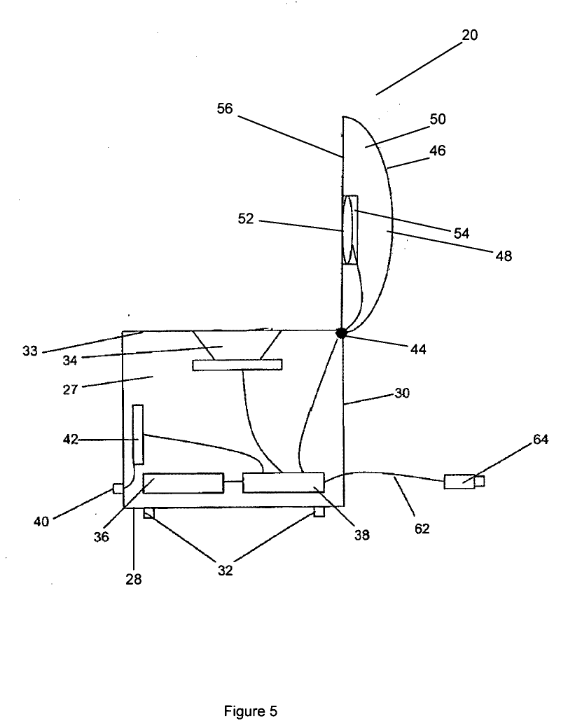

When the webcam speaker 20 is in the second position shown in FIGS. 3 and 5, the position of the first portion 24 relative to the second portion can be adjusted, to facilitate vertical and lateral adjustment of the lens 52, for correct aiming of the lens 52.

In this way the webcam speaker 10 may be used for one or more of:
(a) Internet telephony;
(b) audio reproduction;
(c) image capturing; and
(d) audio/visual conferencing

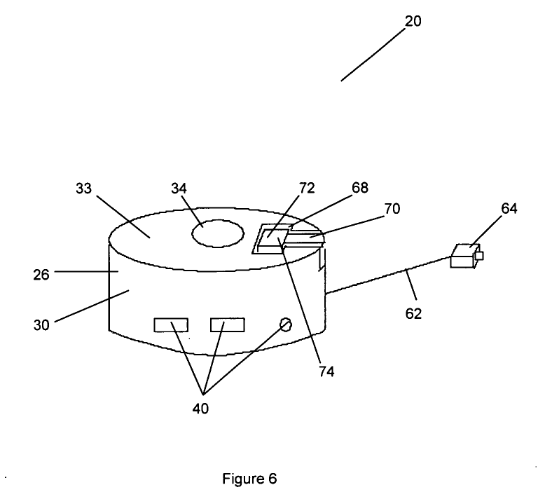

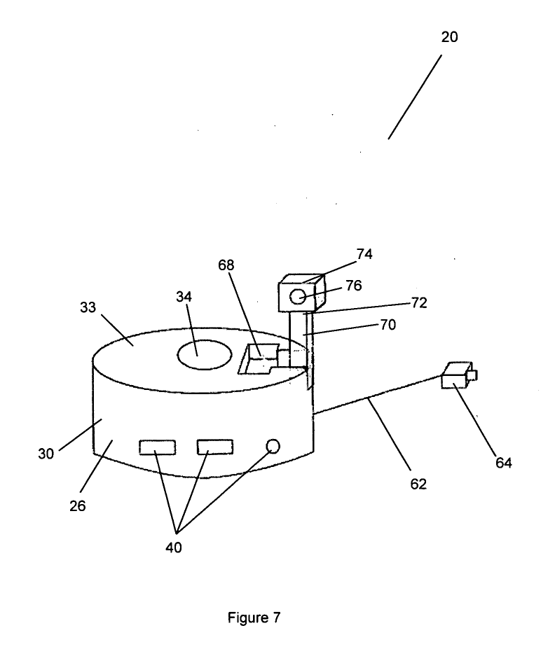

A second embodiment of the webcam speaker 20 is shown in FIGS. 6 and 7. Here, there is a shaped recess 68 formed in top surface 33 for releasably receiving therein a first portion in the form of an arm 70 having mounted at the outer end 72 thereof a body 74 in which is mounted a lens 76 of a webcam. The lens 76 is preferably mounted to body 74 in a ball joint (not shown) to allow for lateral and possibly vertical adjustment for correct aiming of the lens 76. Lateral and vertical movement of the lens 76 may also be automated such as in the instance of face tracking. The inner end of arm 70 is pivotally attached to the second portion 26 for pivotal movement between a first position as shown in FIG. 6, and a second position as shown in FIG. 7. The arm 70 may be telescopic, if required or desired, to assist in vertical adjustment of the lens 76.

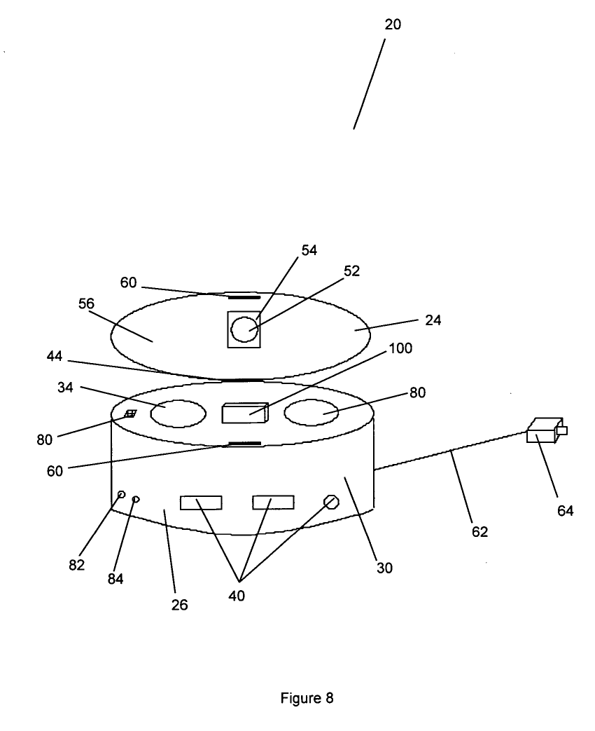

FIG. 8 shows a third embodiment that is a variation of the embodiment of FIGS. 2 to 5. The embodiment of FIG. 8 has a number of extra features, over that of FIGS. 2 to 5. Any one or more of the extra features, or any combination of them, may be utilized. The extra features are:
(a) a second driver 86 spaced from the driver 34 to enable stereophonic audio reproduction rather than monaural audio reproduction (mono);
(b) a built-in microphone 80 to enhance the use of the webcam speaker 20 for Internet telephony and audio/visual conferencing;
(c) a line-out socket 82 for headphones or a remote speaker (a connection to socket 82 may disable drivers 34, 86);
(d) a line-in socket 84 for enabling audio input directly to the webcam speaker 20;
(e) a mute button 88 for the built-in microphone 80;
(f) an automatic-off switch to switch off the webcam speaker 20 when first portion 24 is moved to the first position; and
(g) a connector 100 (that may be retractable) for enabling audio input directly to the webcam speaker 20.

The connector 100 may be a USB connector, a IEEE 1394 connector, a customised connector, or a jack that enables interfacing and functional connectivity with devices that provide video/audio output signals. Devices connected via the connector 100 may also be controllable by a remote control that controls the webcam speaker 20.

Again, any one or more of these six extra features, or any combination of them, may be utilized with the embodiment of FIGS. 6 and 7.

With the inclusion of the features mentioned above, the webcam speaker 20 may be able to allow the superposition of audio and images onto an existing series of moving pictures. It is thus possible to super-impose audio and images taken by the webcam speaker 20 onto scenes of a movie, music video or filmlet played-back from a DVD or from portable movie players like Creative Technology's Portable Media Centre or Zen Vision digital device. The superposition of audio and images may be done with scenes of a movie, music video or filmlet simply being a backdrop. Alternatively, the audio and images captured by the webcam speaker 20 may be merely a sub-window in the scenes of a movie, music video or filmlet or vice versa. Having this facility enables a user to feel like part of a movie, music video or filmlet and be able to transmit the super-imposed effect in real-time or it also enables the capturing of a user's reaction (in a sub-window or in a main display) to a scene of a movie, music video or filmlet and transmitting the super-imposed effect in real-time.

Although the webcam speaker 20 has been shown as being of an ellipsoid shape, it may be of any suitable shape including cuboid, spherical, and so forth.

Whilst there has been described in the foregoing description preferred embodiments of the present invention, it will understood by those skilled in the art that many variations or modifications in details of design, construction and operation may be made without departing from the present invention as defined in the claims.

1. Apparatus for audio reproduction and image capture, the apparatus comprising:
(a) a housing comprising a first portion and a second portion, the first portion being moveable relative to the second portion between a first position and a second position;
(b) at least one loudspeaker driver mounted in the second portion for audio reproduction;
(c) a web camera mounted to the first portion and being moveable at least laterally relative to the first portion;
(d) the first portion being adjustable when in the second position for aiming of the web camera.

2. Apparatus as claimed in claim 1, wherein the first portion is pivotally attached to the second portion.

3. Apparatus as claimed in claim 1, wherein the first portion comprises an outer surface and a front surface for enclosing the outer surface, the web camera being mounted to the front surface.

4. Apparatus as claimed in claim 1, wherein the first portion comprises an arm pivotally attached to the second portion at an inner end of the arm, a body at an outer end of the arm, the web camera being mounted in the body.

5. Apparatus as claimed in claim 4, wherein the arm is telescopic.

6. Apparatus as claimed in claim 4, wherein the second portion has a shaped recess in which the first portion is releasably received when the first portion is in the first position.

7. Apparatus as claimed in claim 3, wherein when the first portion is in the first position the first portion is a cover for the second portion.

8. Apparatus as claimed in claim 7, wherein the second portion comprises a base, a peripheral side wall, and a top surface; the base, peripheral side wall and top surface forming a hollow interior, the at least one loudspeaker driver being mounted in the top surface.

9. Apparatus as claimed in claim 6, wherein the second portion comprises a base, a peripheral side wall, and a top surface; the base, peripheral side wall and top surface forming a hollow interior; the shaped recess being formed in the top surface.

10. Apparatus as claimed in claim 1 further comprising at least one selected from the group consisting of: a built-in microphone, a line-out socket, a line-in socket, a mute button for the built-in microphone, a connector to digital devices and a switch for switching off the apparatus when the first portion is moved to the first position.

11. Apparatus as claimed in claim 8, wherein the hollow interior is acoustically matched to the at least one loudspeaker driver.

12. Apparatus as claimed in claim 9, wherein the hollow interior is acoustically matched to the at least one loudspeaker driver.

13. Apparatus as claimed in claim 8, wherein when the first portion is in the first position, there is a small gap between the front surface and the top surface; the first portion protecting the at least one loudspeaker driver and the second portion protecting the web camera.

14. Apparatus as claimed in claim 1, wherein the at least one loudspeaker driver comprises two spaced-apart loudspeaker drivers.

15. Apparatus as claimed in claim 10, wherein the apparatus is able to super-impose captured audio and images onto existing media content.

16. Apparatus as claimed in claim 15, wherein the media content is selected from the group comprising: movies, music videos and filmlets.

17. Apparatus as claimed in claim 15, wherein the captured audio and images are presented in a sub-window of a main display of the existing media content.

18. Apparatus as claimed in claim 15, wherein the existing media content is presented in a sub-window of a main display of the captured audio and images.
